(19) United States
(12) Patent Application Publication
(10) Pub. No.: US 2025/0267365 A1
(43) Pub. Date: Aug. 21, 2025

(54) HIGH-QUALITY VIDEO STABILIZATION SPECIFICALLY FOR THE DRONE

(71) Applicant: Microavia International Limited, Dublin (IE)

(72) Inventors: Dmitry Popov, Dubai (AE); Anton Babushkin, Zurich (CH)

(21) Appl. No.: 18/581,050

(22) Filed: Feb. 19, 2024

(51) Int. Cl. H04N 23/68; G06T 7/246; G06V 20/17

(52) U.S. Cl. CPC H04N 23/683; G06T 7/246; G06V 20/17; H04N 23/6811; H04N 23/6812; G06V 2201/07

(57) ABSTRACT

Images captured by drone cameras are stabilized through techniques involving video processing, distortion removal, and image enhancing. Oscillation of the camera and captured image is identified and determined and used to create a corrected video image.

### TECHNICAL FIELD

The present invention relates to drone video camera stabilization through techniques involving video processing, distortion removing, and image enhancing.

### BACKGROUND

The “jello effect” (or simply “jello”) is a phenomenon that appears when a rolling shutter camera is vibrating at frequencies higher than the camera frame rate. This effect is most noticeable when the vibration amplitude is high and or when the camera has very narrow FoV (high zoom ratio). The rolling shutter causes the image to wobble unnaturally.

The video obtained from drone cameras has two aspects that characterize its quality. The first is the lack of shake. Shake distorts images taken by both global shutter cameras and rolling shutter cameras. The second is the absence of the jello effect. Jello is typical for the most common rolling shutter cameras that perform line-by-line scanning. The jello effect distorts the video significantly, and it is caused by a vibration during a drone's flight.

Usually, the vibration frequency that produces the jello effect has a spectrum and is higher than the sweep frequency of the camera (usually, 60 Hz) by a factor of about 2-2.5, or around 120-150 Hz. The waves in a video are a combination of different harmonic vibrations that distort the video and degrade its quality.

To remove the jello from the video, the exact parameters of the vibration must be known. For this purpose, it is not enough to know only the information that can be obtained by processing the video data itself. This is because of the inaccuracy of video processing algorithms and observing non-rigid surfaces when algorithms suppose such surfaces are rigid. Examples include water with waves or sand dunes. For this reason, additional information about vibration is required. This information can be obtained from a sensor external to the camera. Such a sensor can be, for example, an inertial measurement unit (IMU).

Thus, a solution is needed for capturing a clear video image without jello-type distortions from a camera mounted on a drone, regardless of the vibrations to which the drone or the camera itself is subjected. But vibrations are not stationary and do not have constant parameters. Therefore, a dynamically updated oscillation model must be used to eliminate the “jello.” It is impossible to calculate in advance a single formula by which one can improve any frame by removing jello. Vibrations and their associated jello change their character over time. Such vibrations can be called quasi-stationary: over time they retain their general character and type, but the specific parameters are constantly changing.

Currently, the main approach to video stabilization is to measure the picture displacement and eliminate it. However, a rolling-shutter camera mounted on a drone creates video with shaking and a jello effect under the influence of vibrations. These vibrations cannot be eliminated completely using current techniques.

There are a number of physical causes for vibrations with a frequency that exceeds the sweep frequency. One cause is the limited stiffness of the drone's frame. If the frame is further reinforced or made monolithic by increasing its stiffness, the amplitude of vibrations will reduce, and video distortion from the jello effect will decrease. Yet another cause for vibrations derives from the limited quality of mechanical dampers that can be used as spacers where the drone frame and camera mount connect. Dampers generally cannot block frame vibrations completely and transfer them to the mount. Vibrations in combination with the peculiarities of a camera with a rolling shutter produce a jello effect. If the camera doesn't have a rolling shutter, the jello effect isn't produced. But such cameras are rare and more expensive than cameras with a rolling shutter. The jello effect is intensified when zooming in, proportional to the zoom factor.

Usual sources of vibration are the operation of the drone's engines and the wind resistance of the blades and the drone itself. Some vibrations can be eliminated by the camera's built-in gyro stabilization. These can be mechanical gyro stabilization or electro-mechanical stabilization with camera movement measurement and compensation of movement by electric motors. However, this mechanism is not capable of blocking all vibrations. Typically, the camera receives external influence in the form of vibration in a certain frequency band, typically, 5-400 Hz. When vibration occurs in the frequency band between 5 Hz and 60 Hz one can observe the “shaking” in the resulting video, while when vibration is between 25 Hz and 400 Hz one can observe the “jello” effect in the video provided that the vibration frequency is higher than the camera frame rate.

The traditional way to deal with the effects of vibration in video images is to select marker points on frames and algorithmically process the video, either after shooting or in real time, so that the marker points and the entire picture on successive frames are shifted to reduce the effects of vibration. This method shows acceptable results in eliminating the effect of displacement of the whole image caused by vibrations based on assumption of exactly the same parallel movement of the marker points. However, this method does not provide good results in removing jello because jello cannot be removed completely based only on the information obtained from the video data itself.

On the other hand, existing methods of removing effects of vibration in video images that use only data obtained from an Inertial Measurement Unit sensor. An Inertial Measurement Unit is an electronic device that measures and can report a body's specific force, angular rate, and the orientation of the body, using a combination of accelerometers and gyroscopes. IMUs are frequently used to maneuver unmanned aerial vehicles (UAVs) and drones. IMUs can also be mounted on the camera body for gimbal stabilization. But methods using IMUs also have drawbacks, including IMU data-transmission delays and inaccurate measurements of IMU data. Also, failure to comply with the requirements for accurate mounting of IMU and/or calibration procedure will impair the results of removing vibration effects from video images. Improved systems and methods for removing vibration effects from video images are needed that overcome these difficulties.

### SUMMARY

In an embodiment, a method is disclosed for stabilizing video being taken by a drone camera using a computing device coupled to a memory and an IMU sensor mounted on the camera's body. A video frame is captured by the drone camera, and comprises a set of pixels. Each pixel has coordinates within the video frame and a color-information value.

A set of values is measured indicating vibrations of the drone camera by obtaining raw data from the IMU sensor when capturing the video frame. A tracking set of corner points for a previous video frame are loaded from memory. The movement of corner points between the previous and the captured video frames is calculated using the tracking set of corner points for the previous video frame and information about pixels of the captured video frame and the previous video frame.

Displacement is added related to the calculated movement of corner points between the previous and the captured video frames to the tracking set of corner points for the captured video frame. The method continues by storing the resulting tracking set of corner points in the memory as a tracking set of corner points for the captured video frame and creating an oscillation model for the captured video frame. The oscillation model is based on a vibration value measured by the IMU sensor corresponding to the captured video frame, and a calculated movement of corner points.

The oscillation model is inverted so that the inverted oscillation model for each pixel of the captured video frame contains information about the point from which the pixel has shifted. The next operation is to generate a corrected video frame by transforming pixels of the captured video frame using the inverted oscillation model and replacing the captured video frame with the corrected video frame in the captured video.

In an alternative embodiment, the raw data obtained from the IMU sensor is recalculated to determine displacement along three axes and the determined displacement is recorded in the memory as vibration values. In another embodiment, a plurality of the measured vibration values correspond to a video frame. In yet another embodiment, a set of lines on the captured video frame corresponds to a measured vibration value.

In some embodiments, the oscillation model is a model describing vibration in a three-dimensional coordinate system and the operation of inverting of the oscillation model includes projecting from the three-dimensional coordinate system to a two-dimensional coordinate system. In an embodiment, the oscillation model is a model describing vibration in a two-dimensional coordinate system.

In an embodiment, a video frame image is downscaled for optimization purposes. In an embodiment, vibration values measured by the IMU sensor are processed by a Kalman filter using information from a GPS unit, a barometer, or a compass, or an altimeter, or IMU sensor mounted on the drone's bode, or a combination of these sensors.

In an embodiment, motion patterns are detected in the captured video frame by comparing the calculated movement of corner points with predefined motion patterns characterizing possible variants of motion in the captured video frame, the motion patterns comprising vibration, optical zoom, or movement of an object. In an alternative embodiment, external objects are detected in the captured video frame by using a neural network, whereas the corner points laying in the area of detected non-static external objects can be excluded from the tracking set of corner points for the captured video frame. In yet another embodiment, a corner point is added to and deleted from the set of corner points for the captured video frame. In an embodiment, calculating the movement of corner points between the previous and the captured video frames is performed using an optical-flow method.

In an embodiment, a system for stabilizing video being taken by a drone camera comprises a drone with an onboard computing device coupled to a memory. An IMU sensor communicatively is coupled to the computing device to a camera for capturing a plurality of video frames, wherein the captured video frames comprise of a set of pixels and wherein each pixel has coordinates within the video frame and a color-information value.

The computing device is configured for measuring a set of values indicating vibrations of the drone camera by obtaining raw data from the IMU sensor when capturing the plurality of video frames. The computing device is further configured for loading from the memory a tracking set of corner points for a previous video frame and for calculating the movement of corner points between the previous and the captured video frames using the tracking set of corner points for the previous video frame and information about pixels of the captured video frame and the previous video frame.

The computing device is further configured for adding displacement related to the calculated movement of corner points between the previous and the captured video frames to the tracking set of corner points for the captured video frame. The computing device is also configured for storing the resulting tracking set of corner points in the memory as a tracking set of corner points for the captured video frame and creating an oscillation model for the captured video frame based on a vibration value measured by the IMU sensor corresponding to the captured video frame and a calculated movement of corner points.

Image processing by the computing device continues by inverting the oscillation model so that the inverted oscillation model for each pixel of the captured video frame contains information about the point from which the pixel has shifted. The computing device generates a corrected video frame by transforming pixels of the captured video frame using the inverted oscillation model and replaces the captured video frame with the corrected video frame in the captured video.

In an embodiment, the system includes a configuration where the onboard computing device is a special-purpose computer configured for processing captured image data and does not serve as the central computer for controlling the drone. In another embodiment, the drone's onboard memory is configured for storing captured video and IMU data during flight.

In an alternative configuration, the drone is a first drone and further comprises an onboard transmitter configured for sending video and IMU sensor data to a second drone. The video and IMU sensor data is processed by the second drone's onboard processor and memory in a similar manner to the procedure described for the first drone.

An embodiment includes a method of image processing that starts by receiving a video frame captured by a remote drone camera and the captured video frame comprises a set of pixels. As in the method already described, each pixel has coordinates within the video frame and a color-information value. The remaining operations of the method proceed as described above until the captured video frame is replaced with the corrected video frame in the captured video.

Variations of this alternative method include a video frame captured by the remote drone camera that is received at a base station and the oscillation model is built at the base station. The method also comprises a variation where the remote drone camera is onboard a first drone and wherein the video frame captured at the first drone is received at a second drone and the oscillation model is built at the second drone. In an alternative embodiment, a plurality of drones equipped with cameras are used to capture video of the same object or surface. If a video captured by one of the drone cameras requires further stabilization and removing of the jello effect, video frames captured by the other drone cameras are used to improve the precision of the oscillation model by stabilizing the video captured by the single drone camera. This can include identifying the same real world object in the images captured by other drones and the associated corner points. The other images are used to more accurately determine the displacement of the corner points by excluding associated corner points from the tracking set of corner points. The exclusion of associated corner points improves the quality of the oscillation model. In an embodiment, the oscillation model created by the method includes correction data obtained by analyzing historical data comprising IMU sensor correction. In an alternative embodiment, historical data is used to calculate the oscillation model and the historical data comprises vibration values from the IMU sensor and displacement data from processing corner points. In yet another embodiment, historical data is used to improve the accuracy of the oscillation model. The historical data contains statistical data about vibration patterns both in the optical area and in the mechanical area.

### BRIEF DESCRIPTION OF THE DRAWINGS

FIG. 1 is a flowchart of a method for drone video camera stabilization, according to an embodiment.

FIG. 2 is a block diagram of a system of drones, according to an embodiment.

FIG. 3 is a schematic diagram of an embodiment of a drone including an onboard camera and IMU sensor.

FIG. 3-1 is an alternative schematic diagram of an embodiment of the drone including an onboard camera and IMU sensor.

FIG. 4 is a block diagram of corner point displacements, according to an embodiment.

### DETAILED DESCRIPTION

Systems and methods eliminate distortions caused by movements having a known character, such as camera vibration, with a pattern that can be modeled with specific parameters, such as harmonic, meander, fading harmonics, linear oscillations, either alone or in combinations.

A system generally comprises a drone, an inertial measurement unit (IMU) sensor, a camera, an onboard computing device, and a memory. These components can be distributed in different ways to improve the processing efficiency of the system. For example, when the drone has a powerful processor, the central onboard computer of the drone can be used as the computing device. In this case, the computing device also provides other functions important for drone flight, such as autopiloting. Alternatively, a dedicated, specialized computer whose primary task is to process image data received from the camera is used as the computing device, leaving other drone functions for the central onboard computer. This configuration removes significant processing workload from the central onboard computer and allows for selection of a less powerful processor.

An alternative configuration moves some or all processing tasks to a remote computing device. For example, the data received from the IMU sensor and the vibration data obtained by processing the video image are transmitted to another drone with relatively more computing resources. The IMU sensor data and vibration data can also be sent to a base station with a computing device configured for building and updating the oscillation model. Such a base station is typically located on the ground, but it could also be airborne in some embodiments.

When tasks such as building the oscillation model are done remotely from the drone, the oscillation model parameters can be sent back to the drone, where data processing is completed. Alternatively, all image processing takes place remotely or image processing is split between the drone's onboard components and remote compute resources.

Another configuration uses onboard capture and storage in combination with remote processing. In this embodiment, captured video and the synchronized IMU data are stored in a local storage of the drone during flight. After landing, the data stored in the drone's onboard storage is processed locally on the drone or transmitted to a base station or remote storage, for further processing using the oscillation model and creating a stabilized video. In this way, the drone's onboard computing device is simultaneously responsible for image processing and general control functions.

Processing of collected data comprises a number of operations, whether it takes place onboard the drone or remotely. In an embodiment, data from the IMU sensor is preprocessed. Preprocessing can take place at the drone's onboard computing device by using, for example, a Kalman filter, or an extended Kalman filter, where a non-linear model with linearization is utilized for each moment. The Kalman filter, also known as linear quadratic estimation (LQE), is an algorithm that uses a series of measurements observed over time, including statistical noise and other inaccuracies, and produces estimates of unknown variables that tend to be more accurate than those based on a single measurement alone. The Kalman filter does this by estimating a joint probability distribution over the variables for each timeframe. The Kalman filter keeps track of the estimated state of the system and the variance or uncertainty of the estimate. The estimate is updated using a state transition model and measurements. Initially, the Kalman filter produces estimates of the current state variables, along with their uncertainties. Once the outcome of the next measurement (necessarily corrupted with some error, including random noise) is observed, these estimates are updated using a weighted average, with more weight being given to estimates with greater certainty. The algorithm is recursive and can operate in real time, using only the present input measurements and the previously calculated state and its uncertainty matrix; no additional past information is required.

Frame images collected by the drone camera are processed according to a color format. Common formats include RGB format (color space) or RAW format or YUY2 format. Other color formats can also be used.

In an embodiment, increasing the effective sampling frequency from the IMU sensor is used to register and compensate for vibration of higher frequency and to improve the quality of video stabilization when transitioning from one vibration to another when the vibration characteristics change.

In an embodiment, historical data on corner points obtained from previous frames of the current video recording is used to build and to update the oscillation model. The oscillation model can then include correction data obtained by analyzing the historical data, such as an IMU sensor alignment correction.

In an embodiment, the construction of the oscillation model is created considering a time delay between the actual time of receiving the data from the IMU sensor and its processing by the computing device to construct the oscillation model.

In an embodiment, historical data are used to calculate and update the oscillation model for the current frame to statistically level out a possible delay in receiving vibration information from the IMU sensor for the current frame. In this case, during creation of the oscillation model, vibration values from the IMU sensor and displacement data obtained during processing of corner points on frames that belong to different timestamps are used to build the oscillation model. Because the oscillation model creation is statistical in nature and includes historical data, this time delay will be leveled out and will not affect the quality of the result. But historical data has limits also. When IMU data is obtained with significant delay and predicted data is used for correction of the current frame, mistakes in prediction may be introduced because physical vibration patterns changed during the delay. In an alternative embodiment, a detecting algorithm discovers changes of physical vibration patterns. The use of historical data to improve the oscillation model is stopped when a change of physical vibration pattern occurs.

In an embodiment, producing the resulting video includes video format conversion and compression.

In an embodiment, internal camera information is used in the oscillation model, such as a current optical zoom ratio and exposure value (shutter time), to improve the quality of video stabilization.

In an embodiment, the analysis of corner point displacements or color-information values of pixels is used to cluster the image and identify a set of objects, including moving objects, that are in the frame. For example, clusters of corner points moving in the same direction correspond to big moving objects in the frame. In an alternative embodiment, a movement compensation method is applied to the captured video frame before applying the oscillation model. This technique compensates for the radial and parallel components of movement of the corner points, and excludes moving objects and associated corner points from the oscillation model.

In embodiments, all operations are performed on the drone itself. Typically, a drone with a camera has an onboard computing device that receives video data from the camera, processes the video data, stores the video data in local storage, and possibly forwards the video to a base station, to a web-server, or to both. In other embodiments, operations are performed both on the drone and on other non-drone components.

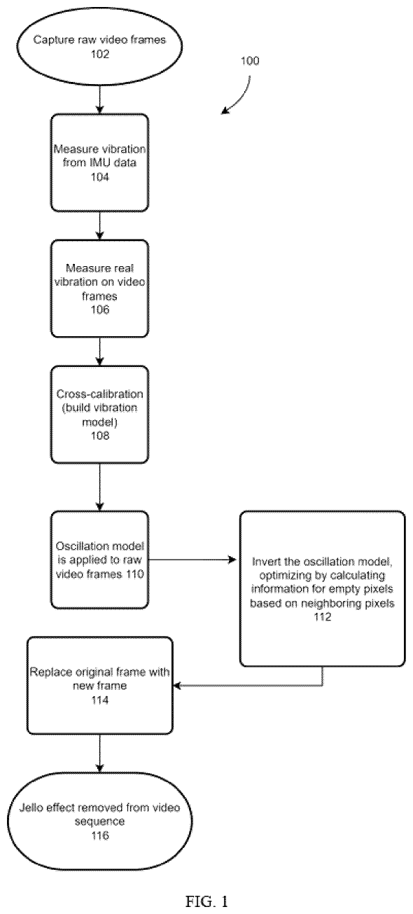

Referring to FIG. 1, a flowchart of a method for drone video camera stabilization is depicted, according to an embodiment. As shown in FIG. 1, method 100 comprises operation 102 of capturing raw video frames. At operation 104, the real vibration of the video camera is measured from the IMU data collected when capturing a given video frame. The result of vibration measurement with the IMU sensor are six values (generally angular speed in three coordinates (pitch, roll, yaw) and linear acceleration in three coordinates (x, y, z)) that can be used to calculate the displacement along three coordinate axes at a given moment of time. This calculation is made because the jello effect results from camera shifting during the time it takes to capture a single frame.

Operation 106 generally comprises measuring the real vibration on the video frames. There are points on the frames for which the movement between frames is most noticeable. These are referred to as corner points. The corner points are detected and updated in real time. A sufficient number of such corner points on one frame is 100-150. These are enough corner points for the jello effect to be eliminated while retaining sufficient image quality. In an example, 100-150 corner points can be utilized. In embodiments, fewer than 100 or fewer than 150 corner points can be utilized. In embodiments, greater than 100 or greater than 150 corner points can be utilized.

By analyzing the vicinity of the corner points, the direction and distance of the picture displacement are calculated in the vicinity relative to a given corner point. The previous and current frames are analyzed. As a result of this analysis, displacement with sub-pixel accuracy can be determined. A statistical operation is used to achieve this result. For example, it can be calculated that the displacement has occurred by 1.5 pixels or even 0.3 pixels. In an embodiment, the original image is downscaled linearly. This results in fewer calculations and optimizes real-time efficiency.

Corner points are typically the actual corner points in the objects that constitute the image in the frame. Corner points are extracted by applying special two-dimensional filters to the image (frames in video), which produce a high value in areas where the image changes greatly. Further, part of the pixels for each frame are processed by a corner-point detector. Part of the newly detected corner points are duplicates of the existing set of corner points. Another part of the corner points is the new points, which are used to replenish the working set of corner points for optical flow measurement.

Optical flow measurement is a technique to estimate the motion between two image frames taken at different times. The technique is differential, meaning it is based on local Taylor series approximations of the image signal, using partial derivatives with respect to spatial and temporal coordinates. Optical flow refers to the pattern of apparent motion of objects, surfaces, and edges in a visual scene caused by the relative motion between the observer and the visual scene. Optical flow also refers to the distribution of apparent velocities of movement of brightness patterns in an image.

Initially the set of corner points can be empty. Then the array of corner points is updated in real time. Updating the array of corner points includes deleting corner points that were classified by the optical flow algorithm as not good for displacement. In an embodiment, such corner points can be corner points with anomalous movement. For example, these are corner points on objects moving relative to other objects in the frame. Then corner points are deleted that are too close to each other as not producing additional information. For example, in an embodiment, coordinates of corner points in the frame can be compared. If the corner points are too close to each other, i.e. the distance between them is less than the threshold value, some of such corner points can be removed without loss of quality of the result. Instead of deleted corner points, new corner points defined randomly in the frame can be added, so that the total number of corner points is not less than the minimum number required for correct operation of the algorithm. Some small amount of random corner points are deleted to refresh the working set of corner points and new corner points are added. For example, one corner point can be removed and replaced.

Thus, by analyzing the corner points on the frames, information is obtained for each frame about the displacement of all corner points for all corner points in a tracking set. Corner point positions are corrected by the measured displacement, so that their positions in the next frame will still be near the “corner” which was detected some frames ago when they were added to the tracking set of corner points.

If all corner points on a frame are shifted synchronously and equally, it is a parallel frame shift. This can be due to low frequency vibration, where the vibration frequency is much lower than the camera sweep frequency. If all corner points move from the center of the frame to the frame borders, this corresponds to optical zoom and the movement component can be ignored. If some corner points move in different directions, it can be a large moving object in the frame. Using the techniques of embodiments, this cluster of corner points can be found and excluded from global movement estimation, jello estimation, or zoom estimation.

If the corner points shift differently, the jello effect results. The conditions for the jello effect arise because vibration frequency is higher than the camera sweep frequency. Each frame can be matched with at least 10 displacement values from the IMU sensor when the camera is shooting at 60 fps. Further increasing the number of IMU sensor vibration values per frame increases the quality of the jello effect removal. In an embodiment, displacement values are generated by the IMU with sampling rates much higher than the frame rate.

In an embodiment, the image for processing comes as a whole frame in uncompressed format such as YUY2. Other color spaces can also be used. In alternative embodiments, images in other formats can be used.

Returning to FIG. 1, operation 108 comprises cross-calibration or building a vibration model. This is an oscillation model of the current vibration. The vibration model is updated by cross-calibrating the displacement values obtained from the IMU sensor and calculated by processing the video frames. The output comprises the actual vibrations, which correspond to individual pixels, lines, or frames. The vibration can be observed through data from the IMU transformed in the form of 3× angles displacement (by using inertial measurement, or the Kalman filter, etc) and through its visual representation on the video frames. In an embodiment, the oscillation model can be a weighted sum model that combines several periodic parametric functions. An example of harmonic periodic function is Ai*sin(OMEGAi*t+PHIi), where Ai−weight, OMEGAi−frequency, PHIi−phase shift. If the oscillation model of 1D oscillation contains N such functions, the model can be described by 3N parameters. For a 2D oscillation model 6N parameters are required in general if 2 different harmonic functions are used for x and y. Alternatively, a 2D vector can be used to set a direction of each harmonic function. In this case 5N parameters are required: 3N for periodic and 2N for direction. Alternatively, a simpler model can be used assuming the scalar oscillations are aligned in one direction. In this case, 3N+2 parameters are used for the oscillation model. For a 3D oscillation model, 9N, or 6N or 3N+3 parameters are used.

It can generally be assumed that these video frames are not accurately synchronized with IMU data. The synchronization can be biased, for example, for the IMU sensor. If there is an unknown delay, a model is built to convert mechanical vibrations to visual vibrations. This is accomplished by using a model to convert the mechanical oscillations (IMU sensor data) to visual oscillations.

Operations 110-116 comprise a technique for generating a new frame without the jello effect. The obtained oscillation model is applied at operation 110 to the raw video frames received from the camera by composing a new frame with newly calculated and displaced pixels relative to the pixels of the original frame, with the displacement of each pixel determined by the constructed oscillation model. When building the oscillation model, each frame is matched with a set of vibration values obtained from the IMU sensor.

The oscillation model can use a 2-dimensional (2D) or 3-dimensional (3D) coordinate system to describe vibration. When the 2D coordinate system is used, raw data from the IMU sensor describing vibration in the 3D coordinate system is converted to a 2D representation. This 2D oscillation model requires less compute power but will be weaker from the point of view of robustness and accuracy. When the 3D coordinate system is used, 2D vibrations measured in the video frame are used in the form of a reconstructed 3D vector aligned with an IMU measurement. In connection with generating a new frame without the jello effect as described in operations 110-116, operations can be performed on pixels as well as on rows and blocks of pixels for acceleration.

The oscillation model describes the direction and distance displacement for each pixel. However, forward use of the oscillation model leads to a distorted resulting picture with lacunae instead of pixels due to the use of interpolation. Forward use of the model in this context generally refers to taking a pixel from the captured video frame, calculating its displacement, and adding the pixel with its new position to the resulting video frame. For this reason, an inverted oscillation model is used at operation 112 to obtain the resulting picture, which relates to the resulting frame instead of the original frame and shows where each pixel of the resulting frame has moved from the original frame. To invert the oscillation model, for each point of the final image we find the point in the original image that will be projected to the chosen point on the final image by applying the visual representation of oscillation. In the case that for some point in the final image there is no point in the original image that projected into such a point in the final image, the pixel information for such a point in the final image will be algorithmically calculated. Thus, the inversion of the oscillation model is performed. The inverted oscillation model will be used to create a new frame without the jello effect.

When the 3D coordinate system is used for the oscillation model, the generation of the corrected video frame includes calculating the projection of the 3D oscillation model to 2D space of the video-frame and inverting the calculated projection for mapping original frame pixels to processed frame pixels. The generation of the corrected video frame can also include applying the inverted oscillation projection mapping to the captured video frame.

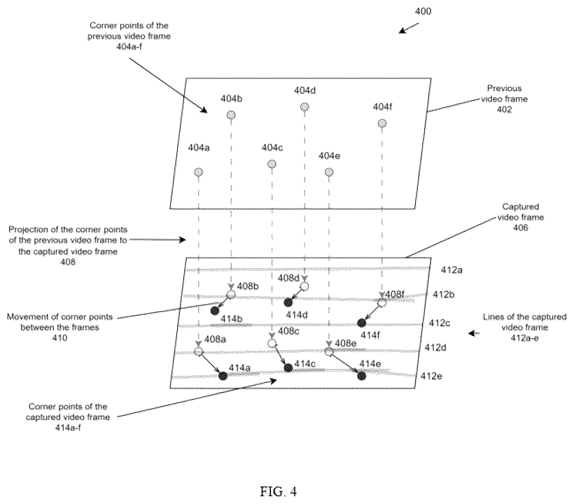

Optimization is performed at operation 112. The computation deals with whole lines rather than individual pixels, since the peculiarity of jello is that all pixels of the same line are shifted uniformly. When lines are side shifted, the information for empty pixels on the resulting frame is calculated based on neighboring pixels. Further details are described with respect to FIG. 4 below.

The object of operation 114-116 is to produce a video sequence without the jello effect. To do this, original frames are replaced by new frames in the video sequence at operation 114. The jello effect is thereby removed from the video sequence at operation 116.

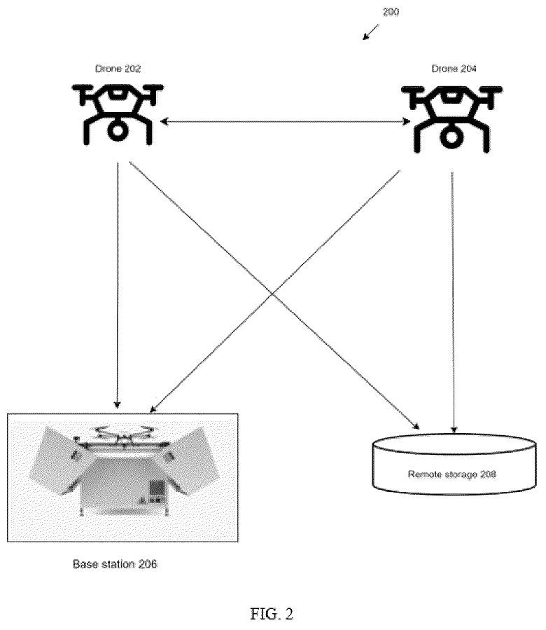

Referring to FIG. 2, a block diagram of a system of drones is depicted, according to an embodiment. In particular, FIG. 2 shows a system 200 for performing the techniques described in connection with FIG. 1. The system comprises a first drone 202, a second drone 204, a base station 206, and remote storage 208. Image data and IMU data are collected by first drone 202, by second drone 204, or by both drones. Drones 202, 204 are in wireless communication with each other. In an embodiment, image data and IMU data collected by drone 202 is transmitted to drone 204 for processing-and vice versa.

In alternative embodiments, image data and IMU data is transmitted from drone 202 to base station 206 or remote storage 208 for processing. Drone 204 likewise can send collected image data and IMU data to base station 206, remote storage 208, or both, for processing in accordance with the embodiments described above.

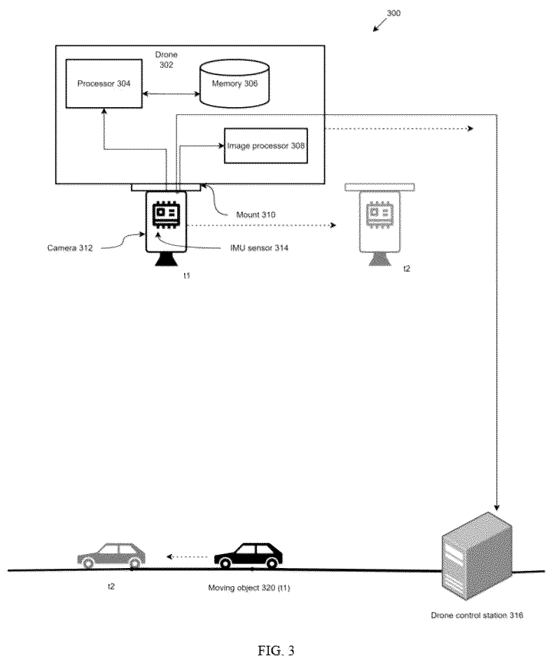

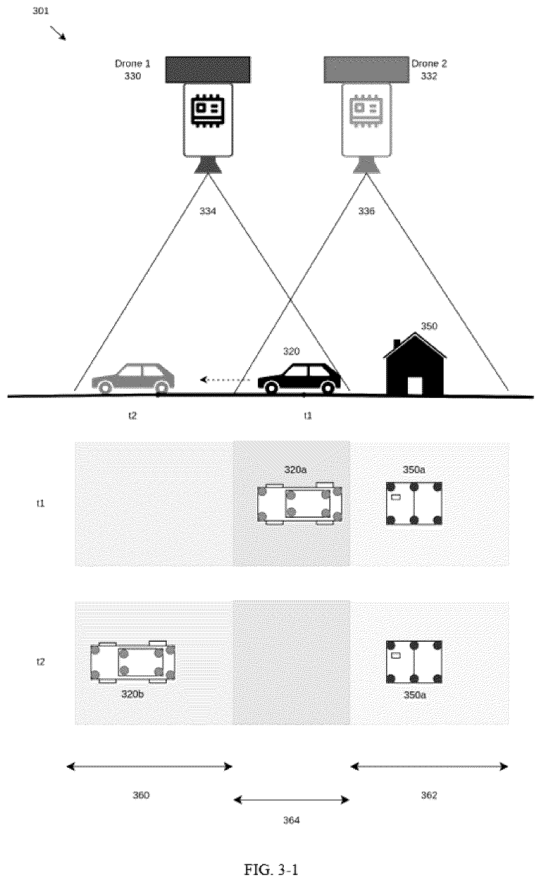

Referring to FIG. 3, a schematic diagram of an embodiment of a drone is depicted, according to an embodiment. FIG. 3 shows further details of a system 300 comprising a drone 302 with an onboard processor 304 and memory 306. In some embodiments, drone 302 also comprises a dedicated image processor 308. In these embodiments, processor 304 acts as the primary controller of drone 302 while image processor 308 handles processing of video frames. Onboard memory 306 of drone 302 is configured for storing captured video and IMU data during flight, as well as tracking sets of corner points related to video frames. Optionally, a second drone, such as shown in FIG. 2, is also configured with an onboard memory for storage of video and IMU data. The second drone also has an onboard main processor (or dedicated image processor) that is configured as drone 302 for image processing.

Drone 302 further comprises mount 310 which is coupled with camera 312 and IMU sensor 314. In embodiments such as the one shown in FIG. 3, IMU sensor 314 is mounted on the same frame as the camera or is part of the camera. In other words, IMU sensor 314 has a rigid mechanical connection with the camera. IMU sensor 314 can be of various types; for example, a sensor capable of measuring vibration in a wider frequency band can be used to improve the quality of the results. Generally, IMU sensors have an effective vibration frequency measurement bandwidth up to 6 kHz.

Drone control station 316 is configured to receive image data from drone 302. In some embodiments, raw video frames and IMU data are sent from drone 302 to control station 316 for processing. In these embodiments, the image processing operations described in connection with FIG. 1 are performed at control station 316 instead of onboard drone 302.

In FIG. 3, drone 302 travels in a direction opposite to moving object 320. The vibration of camera 312 is enough to cause the jello effect if no corrections are made. The movement of object 320 from its position at t1 to its position at t2 creates a noise that hinders the measurement of optical vibration to eliminate the jello effect.

FIG. 3-1 shows an alternative embodiment with moving object 320. In FIG. 3-1, drone 1 330 and drone 2 332 capture video frames with cameras 334 and 336. Top views at times t1 and t2 are also shown. Stationary object 350 (a house) corresponds to the top view of stationary object 350a at times t1 and t2. Moving object 320 at time t1 corresponds to top view 320a, when object 320a is in overlapping zone 364. Moving object 320 at time t2 corresponds to top view 320b. The views of cameras 334 and 336 are represented at times t1 and t2 by zones 360, 362, and 364. Zone 360 is within the exclusive view of camera 334. Zone 362 is within the exclusive view of camera 336. Zone 364 is an overlapping area covered by both cameras 334 and 336. Stationary object 350 is within the view of camera 336.

The regions of the corner points in the captured video frames are identified by each of drones 330 and 332 using a neural network with different confidence. The region of corner points identified by drone 1 330 using information 320a and 320b has better confidence than the region of corner points identified by drone 2 332 using only information 320a. The re-identification reveals the nature of objects to which the regions of corner points correspond. In FIG. 3-1, the objects captured by image frames are moving object 320 that is reidentified using information with better confidence from drone 1 330 and stationary house 350 that is reidentified using information from drone 2 332. The region of corner points identified by drone 2 332 with low confidence is recognized as moving object 320 using information and confidence from drone 1 330. Information about objects 320 and 350 in image frames collected at times t1 and t2 is used to build a more accurate model of the surface captured by cameras 334 and 336 that includes these objects. The region of the corner points that correspond to the moving object 320 is removed from the tracking sets of the corner points used by each drone 330 and 332 to calculate their oscillation models to improve the results of removing the jello effect from the video images captured with cameras 334 and 336. The different calculations result from the nature and frequency of vibrations on each drone.

Referring to FIG. 4, a block diagram of corner point displacements is depicted, according to an embodiment. FIG. 4 shows an example 400 of the movement and displacement of corner points between the previous and captured video frames. A previous video frame 402 has corner points 404a-f. Captured video frame 406 is related to previous video frame 402 by way of projection 408, which places corner points 404a-f at corresponding positions 408a-f in captured video frame 406. Movement of the corner points between frames 410 accounts for the repositioning of the corner points 414a-f in captured video frame 406. Lines of the captured video frames 412a-e are shown for reference. The repositioned corner points 414a-f of the captured video frame 406 reflect the result of between-frame movement 410.

From FIG. 4, corner points in the vicinity of one frame line 412 move in approximately the same way. Corner points in the vicinity of different frame lines 412 move in different directions. For example, points 408b, 408d, and 408f move generally leftward with respect to line 412b while points 408a, 408c, and 408e move generally rightward with respect to line 412d. The difference in movement 410 is due to vibration that occurred during the time between shooting different lines of the same frame. As a result, information obtained about pixels in the lines 412a-e was affected.

Movement of corner points between a previous frame and the captured frames is determined and calculated as shown in FIG. 4. The displacement of all corner points of the captured video frame is extrapolated from the calculated movement of some corner points between the frames. The results of optimization are used to generate a new frame without the jello effect as described above in connection with operation 114-116 of FIG. 1.

1. A method of stabilizing video being taken by a drone camera using a computing device coupled to a memory and an IMU sensor, the method comprising:
capturing a video frame by the drone camera, wherein the captured video frame comprises a plurality of lines, wherein each of the plurality of lines corresponds to a time and comprises a plurality of pixels having coordinates within the video frame and a color-information value;
measuring a set of values indicating vibrations of the drone camera by obtaining raw data from the IMU sensor when capturing the video frame;
loading from the memory a tracking set of corner points for a previous video frame;
calculating movement of corner points between the previous video frame and the captured video frame using the tracking set of corner points for the previous video frame and information about pixels of the captured video frame and the previous video frame;
adding displacement related to the calculated movement of corner points between the previous video frame and the captured video frame to the tracking set of corner points for the captured video frame;
storing the resulting tracking set of corner points in the memory as a tracking set of corner points for the captured video frame;
creating an oscillation model for the captured video frame based on:
a set of vibration values measured by the IMU sensor corresponding to the captured video frame, and
a calculated movement of corner points;
inverting the oscillation model so that the inverted oscillation model for each pixel of the captured video frame contains information about the point from which the pixel has shifted;
generating a corrected video frame by transforming pixels of the captured video frame using the inverted oscillation model; and
replacing the captured video frame with the corrected video frame in the captured video.

2. The method of claim 1, wherein the raw data obtained from the IMU sensor is recalculated to determine a displacement of the set of vibration values along three axes and the displacement is recorded in the memory as vibration values.

3. The method of claim 1, wherein a plurality of the measured vibration values correspond to a video frame.

4. The method of claim 1, wherein the oscillation model is a model describing vibration in a three-dimensional coordinate system and the operation of inverting of the oscillation model includes projecting from the three-dimensional coordinate system to a two-dimensional coordinate system.

5. The method of claim 1, wherein the oscillation model is a model describing vibration in a two-dimensional coordinate system.

6. The method of claim 1, wherein a video frame image is downscaled for optimization.

7. The method of claim 1, wherein vibration values measured by the IMU sensor are processed by a Kalman filter using information from a GPS unit, a barometer, or a compass.

8. The method of claim 1, wherein motion patterns are detected in the captured video frame by comparing the calculated movement of corner points with predefined motion patterns characterizing possible variants of motion in the captured video frame, the motion patterns comprising vibration, optical zoom, or movement of an object.

9. The method of claim 1, wherein a corner point can be added to and deleted from the set of corner points for the captured video frame.

10. The method of claim 1, wherein calculating the movement of corner points between the previous and the captured video frames is performed using an optical-flow method.

11. A system for stabilizing video being taken by a drone camera, the system comprising:
a drone with an onboard computing device coupled to a memory;
an IMU sensor communicatively coupled to the computing device;
a camera for capturing a plurality of video frames, wherein the captured video frames comprise of a set of pixels and wherein each pixel has coordinates within the video frame and a color-information value;
wherein the computing device is configured for:
measuring a set of values indicating vibrations of the drone camera by obtaining raw data from the IMU sensor when capturing the plurality of video frames;
loading from the memory a tracking set of corner points for a previous video frame;
calculating movement of corner points between the previous video frame and the captured video frame using the tracking set of corner points for the previous video frame and information about pixels of the captured video frame and the previous video frame;
adding displacement related to the calculated movement of corner points between the previous video frame and the captured video frame to the tracking set of corner points for the captured video frame;
storing the resulting tracking set of corner points in the memory as a tracking set of corner points for the captured video frame;
creating an oscillation model for the captured video frame based on:
a vibration value measured by the IMU sensor corresponding to the captured video frame, and
a calculated movement of corner points;
inverting the oscillation model so that the inverted oscillation model for each pixel of the captured video frame contains information about the point from which the pixel has shifted;
generating a corrected video frame by transforming pixels of the captured video frame using the inverted oscillation model; and
replacing the captured video frame with the corrected video frame in the captured video.

12. The system of claim 11, wherein the onboard computing device is a special-purpose computer configured for processing captured image data and does not serve as the central computer for controlling the drone.

13. The system of claim 11, wherein the memory is configured for storing captured video and IMU data during flight.

14. The system of claim 11, wherein the drone comprises a first drone and further comprises an onboard transmitter configured for sending video and IMU sensor data to a second drone.

15. A method of stabilizing video taken by a remote drone camera using a computing device coupled to a memory and an IMU sensor, the method comprising:
receiving a video frame captured by the remote drone camera, wherein the captured video frame comprises a set of pixels, and wherein each pixel has coordinates within the video frame and a color-information value;
measuring a set of values indicating vibrations of the drone camera by obtaining raw data from the IMU sensor when capturing the video frame;
loading from the memory a tracking set of corner points for a previous video frame;
calculating the movement of corner points between the previous video frame and the captured video frame using the tracking set of corner points for the previous video frame and information about pixels of the captured video frame and the previous video frame;
adding displacement related to the calculated movement of corner points between the previous video frame and the captured video frame to the tracking set of corner points for the captured video frame;
storing the resulting tracking set of corner points in the memory as a tracking set of corner points for the captured video frame;
creating an oscillation model for the captured video frame based on:
a vibration value measured by the IMU sensor corresponding to the captured video frame, and
a calculated movement of corner points;
inverting the oscillation model so that the inverted oscillation model for each pixel of the captured video frame contains information about the point from which the pixel has shifted;
generating a corrected video frame by transforming pixels of the captured video frame using the inverted oscillation model; and
replacing the captured video frame with the corrected video frame in the captured video.

16. The method of claim 15, wherein the video frame captured by the remote drone camera is received at a base station and the oscillation model is built at the base station.

17. The method of claim 15, wherein the remote drone camera is onboard a first drone and wherein the video frame captured at the first drone is received at a second drone and the oscillation model is built at the second drone.

18. The method of claim 15, wherein the video frame comprises an image of an object, the remote drone camera is mounted on a first drone, and a second remote drone camera is mounted on a second drone, the method further comprising:
capturing, with the remote drone camera, a first plurality of video frames corresponding to the object;
capturing, with the second remote drone camera, a second plurality of video frames corresponding to the object;
determining a higher confidence of the second plurality of video frames based on a region of a corner point of the video frame; and
reidentifying the object in the first plurality of video frames.

19. The method of claim 15, wherein the oscillation model includes correction data obtained by analyzing historical data comprising IMU sensor correction.

20. The method of claim 15, wherein historical data is used to calculate the oscillation model and the historical data comprises vibration values from the IMU sensor and displacement data from processing corner points.
